(19) United States
(12) Patent Application Publication
(10) Pub. No.: US 2026/0266214 A1
(43) Pub. Date: Sep. 10, 2026

(54) POWER GENERATION UNIT AND POWER PLANT

(71) Applicant: WÄRTSILÄ FINLAND OY, Vaasa (FI)

(72) Inventors: Hannu JERONEN, Vaasa (FI); Carl DAMÉN, Vaasa (FI); Emil KIVILINNA, Vaasa (FI); Rami BERG, Vaasa (FI); Verneri FLEEN, Vaasa (FI); Otto PENTTILÄ, Vaasa (FI); Andreas JUNELL, Vaasa (FI)

(73) Assignee: WÄRTSILÄ FINLAND OY, Vaasa (FI)

(21) Appl. No.: 18/869,405

(22) PCT Filed: May 31, 2022
(86) PCT No.: PCT/FI2022/050371

§ 371 Date: Nov. 26, 2024

(51) Int. Cl. F02B 63/04; F02B 37/007; F02B 75/22; F02D 29/06; F02M 21/02; F02M 35/10

(52) U.S. Cl. CPC F02B 63/042; F02B 37/007; F02B 75/22; F02D 29/06; F02M 21/0245; F02M 35/10157

(57) ABSTRACT

The power generation unit for a power plant includes an engine operable using a gaseous fuel, a generator arranged at a first end of the engine, a turbocharger, an air inlet for introducing intake air into the turbocharger or air into a space surrounding the engine, an exhaust duct section for the turbocharger, the exhaust duct section including an outlet connectable to a downstream side exhaust duct section, and electrical equipment for controlling operation of the engine, the generator and/or auxiliary equipment. The air inlet, outlet and electrical equipment are arranged on a second end side of the engine and at a distance from the end, the electrical equipment being arranged below a first level, the air inlet being arranged above the first level, and the outlet being arranged above a second level located above the air inlet.

### TECHNICAL FIELD OF THE INVENTION

The present invention concerns a power generation unit for a power plant, as defined in claim 1. The invention further relates to a power plant.

### BACKGROUND OF THE INVENTION

Power plants that are based on internal combustion engines and generators that are driven by the internal combustion engines provide a flexible solution to power demand for example in power grids where the power demand may change rapidly or where the power supply varies due to the varying availability of solar power, wind power or other renewable energy. Such power plants are also convenient as emergency power plants, as the engines can be started up quickly.

Power plants can often be constructed using standard engines and generators that do not require significant customization. However, in addition to the engines and generators, the power plants need a lot of other equipment serving the operation of the engines.

Due to the need to cut the emissions of the engines, the ability to use gaseous fuels to operate the engines is becoming more and more important. A disadvantage of gaseous fuels is the explosion hazard caused by leaking gas. The use of gaseous fuels requires safety measures, which makes offering solutions for power plants more complicated.

Often the power plants are used in hot climate, which poses challenges to the reliability and durability of various components, in particular electrical components.

### SUMMARY OF THE INVENTION

An object of the invention is to provide an improved power generation unit for a power plant. The characterizing features of the power generation unit ac-cording to the invention are listed in claim 1. Another object of the invention is to provide an improved power plant.

The power generation unit according to the invention comprises
an internal combustion engine that is configured to be operable using at least a first, gaseous fuel, the engine having a first end and a second end,
a generator arranged at the first end of the engine to be driven by the engine,
at least one turbocharger,
at least one air inlet for introducing intake air into the turbocharger or air into a space surrounding the internal combustion engine,
a first exhaust duct section for conducting exhaust gas from the turbocharger, the first exhaust duct section comprising an outlet that is configured to be connectable to a second, downstream side exhaust duct section, and
a set of electrical equipment comprising components dedicated to controlling of the operation of the engine, the generator and/or auxiliary equipment serving the operation of the engine and/or the generator, the components comprising at least one processor configured to control the operation of the engine, the generator and/or the auxiliary equipment.

The at least one air inlet, the outlet of the first exhaust duct section and the set of electrical equipment are arranged on the second end side of the engine and in the longitudinal direction of the engine at a distance from the second end of the engine, the set of electrical equipment is arranged below a first imaginary horizontal level, the air inlet is arranged above the first horizontal level, and the outlet of the first exhaust duct section is arranged above a second imaginary horizontal level, the second horizontal level being located above the air inlet.

The power generation unit according to the invention enables safety and reliability of a power plant. The inlet of the air duct section between the outlet of the exhaust duct section and the set of electrical equipment creates a cooler zone between the electrical equipment and the exhaust duct and protects the electrical equipment from the heat of the exhaust gas. This is beneficial especially in hot climate, and allows thus using a similar power plant layout in various climatic conditions. As the inlet is arranged at a distance from the engine, it can be located away from any connections for gaseous fuel, which improves the safety of the power generation unit. The power generation unit can be used with different engine hall configurations with similar safety benefits.

According to an embodiment of the invention, the set of electrical equipment, the air inlet and the outlet of the first exhaust duct section are arranged in one or more self-supporting modules. Due to the modular structure, greater part of the installation work of the power generation unit can be done prior transporting the equipment to the construction site. This reduces the risk defective installation and thus improves the safety of the power generation unit.

According to an embodiment of the invention, the power generation unit comprises at least two self-supporting modules and the set of electrical equipment is arranged in a first module, the air inlet is arranged in a second module and the outlet of the first exhaust duct section is arranged in the second module or in an optional third module, the modules being independently moveable and configured to be arranged one on top of the other such that the first module forms a lowermost module, the second module can be arranged on top of the first module, and the optional third module can be arranged on top of the second module.

Two or three separate modules make the lifting and transporting of the modules easier and improve safety during the installation.

According to an embodiment of the invention, the power generation unit comprises three self-supporting modules and the outlet of the first exhaust duct section is arranged in the third module.

According to an embodiment of the invention, the air inlet is part of an air duct section that is configured for conducting intake air to the turbocharger or air into a space surrounding the internal combustion engine.

According to an embodiment of the invention, the air duct section is a ventilation duct section that is configured for conducting ventilation air into a space surrounding the internal combustion engine.

According to an embodiment of the invention, the air inlet is configured for introducing ventilation air into a space surrounding the engine, and the power generation unit further comprises at least one intake duct section for conducting air to the at least one turbocharger, the intake duct section comprising an inlet that is configured to be connectable to an upstream side intake duct section or to an air filter, the inlet of the intake duct section being arranged above the first horizontal level, and below the second horizontal level. Ventilation air and intake air is thus supplied via the same zone, thus creating effective heat shield zone between the exhaust duct and the electrical equipment.

According to an embodiment of the invention, the inlet of said at least one intake duct section is arranged in the second module.

According to an embodiment of the invention, the power generation unit comprises at least a first turbocharger and a second turbocharger and said at least one intake duct section comprises a first intake duct section configured for supplying intake air to the first turbocharger and a second intake duct section configured for supplying intake air to the second turbocharger. The two intake duct sections help creating a wider heat shield zone between the exhaust duct and the set of electrical equipment.

According to an embodiment of the invention, the first intake duct section and the second intake duct section are arranged in a horizontal direction on opposite sides of the air inlet. Together the air inlet and the intake ducts thus create a wide heat shield zone between the exhaust duct and the set of electrical equipment.

According to an embodiment of the invention, the first exhaust duct section comprises two branches, each of the branches being connectable to one of the turbochargers.

According to an embodiment of the invention, the two branches merge to form a single exhaust duct on the upstream side of the outlet of the first exhaust duct section. The single exhaust duct section can be located in a manner best utilizing the heat shield zone created by the flowing air and air ducts.

According to an embodiment of the invention, air supply routes from one or more air inlets to the at least one turbocharger and/or into the space surrounding the engine are configured such that flowing air and/or ducts conveying air and the structures covering the ducts create between the first exhaust duct section and the set of electrical equipment a heat shield zone that covers at least 80 percent of the footprint of the structure, in which the set of electrical equipment is arranged. The heat shield zone thus effectively blocks heat of the exhaust gas.

According to an embodiment of the invention, the power generation unit comprises a double-walled fuel supply pipe for supplying the first fuel to the engine, the fuel supply pipe having an upstream side end configured to be connectable to an upstream side fuel supply pipe, said upstream side end being arranged below the first level and in the lateral direction of the engine outwards from the engine. This improves the safety, as potential gas leakage locations are not positioned close to the air inlets or the set of electrical equipment.

According to an embodiment of the invention, said upstream side end of the fuel supply pipe is arranged at a distance of at least 2 m from the air inlet and the set of electrical equipment.

According to an embodiment of the invention, the power generation unit comprises a fuel supply module comprising fuel connections for connecting the double-walled fuel supply pipe to the upstream side fuel supply pipe. The fuel supply module helps ensuring that the fuel connections are made correctly and any gas leakages are avoided.

According to an embodiment of the invention, the fuel supply module is arranged from the positions of the air inlet and the set of electrical equipment towards the first end of the engine. This improves the safety, as potential gas leakage locations are not positioned close to the air inlets or the set of electrical equipment.

According to an embodiment of the invention, the power generation unit comprises an engine hall, inside which the engine and the generator are arranged, the air inlet and the outlet of the first exhaust duct section being arranged outside of the engine hall. By arranging the air inlet outside the engine hall, cooler air is drawn through the air inlet, thus providing effective heat shield zone below the exhaust duct.

According to an embodiment of the invention, the power generation unit comprises means for adjusting the position of the first exhaust duct section to connect it to the turbocharger. This reduces the need for installation work of the exhaust duct at the construction site and ensures tight and safe connections.

According to an embodiment of the invention, the set of electrical equipment comprises any of the following devices: frequency converter for controlling the operation of a ventilation fan, oil mist separator, preheating circulation pump or a pre-lubrication pump; turbo washing unit; motor of a lube oil emptying pump; motor of a preheating circulation pump. By arranging at least some, preferably all of the devices below the air inlet, more space is left below the exhaust duct for conducting air into the engine and the engine hall. This facilitates creating a heat shield zone between the set of electrical equipment and the exhaust duct.

According to an embodiment of the invention, the engine is a V-engine.

A power plant according to the invention comprises at least one power generation unit defined above.

According to an embodiment of the invention, the power plant comprises a plurality of power generation units.

According to an embodiment of the invention, the power plant comprises a common main fuel supply pipe that is configured to supply the first fuel to each power generation unit of the power plant. This reduces the amount of piping at the power plant and facilitates safe working at the power plant.

According to an embodiment of the invention, each power generation unit is connected to the main fuel supply pipe at a location that is at least 2 meters from the air inlets and the set of electrical equipment of the respective power generation unit and any adjacent power generation unit. This improves the safety, as potential gas leakage locations are not positioned close to the air inlets or the set of electrical equipment.

According to an embodiment of the invention, the main fuel supply pipe is arranged outside of any engine halls accommodating the engines and the generators. The number of potential gas leakage locations inside the engine halls are thus reduced.

According to an embodiment of the invention, the main fuel supply pipe is arranged such that the air inlet of each power generation unit is located between the main fuel supply pipe and the respective engine. The main fuel supply line is thus located far from the engines.

According to an embodiment of the invention, the arrangement comprises for each power generation unit a cooling unit that is arranged on the second end side of the respective engine at a distance from the second end. The cooling unit thus leaves the first end of the engine free and safe access to the generator is provided.

According to an embodiment of the invention, the cooling is unit arranged farther from the engine than any fuel supply pipe supplying the first fuel to the engines. The cooling unit is thus arranged far from the air inlets, which ensures that cool air is drawn via the air inlet.

### BRIEF DESCRIPTION OF THE DRAWINGS

Embodiments of the invention are described below in more detail with reference to the accompanying drawings, in which

FIG. 1 shows a power generation unit according to an embodiment of the invention,

FIG. 2 shows another view of the power generation unit of FIG. 1,

FIG. 3 shows a rear view of an air module of a power generation unit according to an embodiment of the invention,

FIG. 4 shows a perspective front view of the air module of FIG. 3,

FIG. 5 shows an engine hall accommodating a power generation unit according to an embodiment of the invention,

FIG. 6 shows a partially cut view of the engine hall of FIG. 5,

FIG. 7 shows a power plant according to an embodiment of the invention, and

FIG. 8 shows a power plant according to another embodiment of the invention.

### DETAILED DESCRIPTION OF EMBODIMENTS OF THE INVENTION

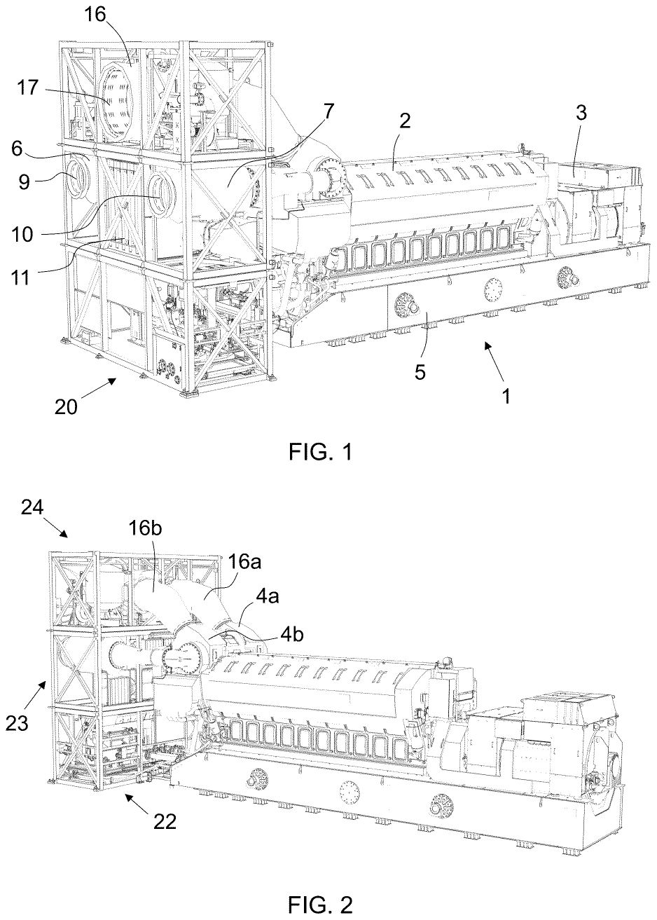

FIGS. 1 and 2 show a power generation unit 1 according to an embodiment of the invention. The power generation can be used as a part of a power plant. The power plant is configured to generate at least electrical power. The power plant could additionally generate heat, for instance by utilizing the heat of exhaust gas produced by the engines of the power plant or the heat of cooling liquid used for cooling components of the engines. The power plant could comprise a single power generation unit 1, but the power plant can comprise two or more power generation units 1, for instance 3-16 power generation units 1. However, the number of power generation units 1 can be even larger than 16. The term “power plant” refers here to a facility that is configured to supply electricity to an electrical network constantly or periodically. The electrical network could be an open network that is accessible by several independent electricity users. However, the electrical network could also serve only a single facility, such as a factory or a mine.

The power generation unit 1 according to the invention could also be used as an emergency power unit, which is started only in case regular power supply in a facility, such as a hospital, factory or nuclear power plant is interrupted.

The power generation unit 1 comprises an internal combustion engine 2. The internal combustion engine 2 is a piston engine. The engine 2 is a large piston engine, which refers here to an engine, in which the cylinder bore, i.e. the internal diameter of the cylinders of the is at least 150 mm. The engine 2 can comprise any reasonable number of cylinders, for instance 5-16 cylinders. The cylinders can be arranged in line or in a V-configuration. The engine of the figures is a V-engine. The engine 2 is preferably a four-stroke engine, but the engine 2 could also be a two-stroke engine. The engine 2 can be a compression or spark ignition engine.

The engine 2 has a longitudinal direction that is parallel to the rotation axis of the crankshaft of the engine 2. The engine 2 has a first end and a second end, which are opposite ends in the longitudinal direction of the engine 2.

The engine 2 is configured to be operable using at least a first, gaseous fuel. The expression “gaseous fuel” refers here to a fuel that is gaseous in atmospheric pressure and at a temperature of 20° C. The first fuel can be, for instance, natural gas or biogas. The term “biogas” refers here to a gas that mainly consists of methane and which is obtained from renewable sources. The biogas can be produced for example from organic waste. Natural gas could be stored either as a liquefied gas (LNG) or compressed gas (CNG). Biogas could be stored in a similar manner. The gaseous fuel does not need to be stored at the power plant, but the gaseous fuel could be supplied to the power plant via a pipeline from a remote storage or production facility.

Instead of methane-based fuels, the first fuel could be, for instance, hydrogen.

The engine 2 can be further configured to be operable using a second fuel. The second fuel can be either gaseous fuel or liquid fuel. If the first fuel is natural gas or biogas, the second fuel could be, for instance, hydrogen. Alternatively, the second fuel could be liquid fuel, such as light fuel oil or heavy fuel oil. The engine 2 can also be operable using one or more further fuels.

The engine 2 can thus be a gas engine, a dual-fuel engine or a multi-fuel engine. The engine 2 is thus configured to be operable using at least one gaseous fuel. In addition to that, the engine 2 can be configured to be operable using one or more additional gaseous fuels, and/or one or more liquid fuels.

The engine 2 can be configured to be operable using mixtures of different fuels. For instance, the engine 2 could be operable using a mixture of hydrogen and some other gaseous fuel and/or a mixture of ammonia and some other gaseous fuel.

When the engine 2 is operated using a gaseous fuel, it can utilize a liquid fuel, such as light fuel oil as a pilot fuel facilitating ignition of the gaseous fuel. However, that is not necessary, but the gaseous fuel could be self-igniting or spark plugs or other ignition means could be used for igniting the gaseous fuel.

The engine 2 can thus provide a great flexibility in the fuel use. However, that is not necessary, but the engine 2 could also be configured to be operable using a single gaseous fuel type.

The power generation unit 1 comprises a generator 3. The generator 3 is arranged at the first end of the engine 2. The first end of the engine 2 is thus a drive end and the second end is a free end. The generator 3 is arranged to be driven by the engine 2. The generator 3 is thus coupled to the engine 2 in such a way that the rotating motion of the crankshaft of the engine 2 can be converted into a rotating motion of the rotor of the generator 3.

In the embodiments of the figures, the engine 2 and the generator 3 are arranged on a common base frame 5. The base frame 5 is configured to be resiliently supported against a floor of an engine hall or against a similar horizontal support surface. The common base frame 5 simplifies the construction work of the power plant. However, the engine 2 and the generator 3 could also be supported by means of a different support arrangement, for instance by separate base frames.

The power generation unit 1 further comprises at least one turbocharger 4a, 4b. The turbocharger 4a, 4b is configured to receive exhaust gas from the engine 2 and to pressurize intake air of the engine 2. The exhaust gas rotates a turbine, which drives a compressor pressurizing the intake air. In the embodiments of the figures, the power generation unit 1 comprises a first turbocharger 4a and a second turbocharger 4b. Each turbocharger 4a, 4b is configured to receive exhaust gas from one cylinder bank of the engine 2.

Many different turbocharger configurations are possible. For instance, in particular in case of a line engine, there could be a single turbocharger supplying intake air into all cylinders of the engine. The power generation unit 1 could also be provided with two turbochargers that are arranged in series to pressurize the intake air in two stages.

The power generation unit 1 further comprises an air inlet 9, 10, 11 for introducing intake air into the turbocharger 4a, 4b or air into a space surrounding the internal combustion engine 2. The space surrounding the engine 2 can be the interior or part of the interior of an engine hall accommodating one or more engine-generator sets, or other space in which the engine-generator sets are located.

The power generation unit 1 further comprises a first exhaust duct section 16, 16a, 16b for conducting exhaust gas from the turbocharger 4a, 4b. The first exhaust duct section 16, 16a, 16b comprises an outlet 17 that is configured to be connectable to a second, downstream side exhaust duct section 19. In the embodiments of the figures, the first exhaust duct section comprises two branches 16a, 16b and each branch 16a, 16b is connectable to an exhaust outlet of a turbocharger 4a, 4b. The branches 16a, 16b join together to form a common exhaust duct portion 16 for both turbochargers 4a, 4b. The first exhaust duct section 16 thus comprises a single outlet 17. However, there could also be separate first exhaust duct sections 16 for the two turbochargers 4a, 4b. If the power generation unit 1 was provided with only one turbocharger or the turbochargers were arranged in series, two branches would not be needed.

The power generation unit 1 further comprises a set of electrical equipment 20 comprising components dedicated to controlling of the operation of the engine 2, the generator 3 and/or auxiliary equipment serving the operation of the engine 2 and/or the generator 3. The components comprise at least one processor configured to control the operation of the engine 2, the generator 3 and/or the auxiliary equipment. The processor can be part of a local control panel of the engine 2. The set of electrical equipment 20 can further comprise at least one of the following: frequency converter for controlling the operation of a ventilation fan, oil mist separator, preheating circulation pump or a pre-lubrication pump; turbo washing unit; motor of a lube oil emptying pump and motor of a preheating circulation pump. Preferably all the above-mentioned devices, if present in the power generation unit 1, are part of the set of electrical equipment 20.

The air inlet 9, 10, 11, the outlet 17 of the first exhaust duct section 16, 16a, 16b and the set of electrical equipment 20 are arranged on the second end side of the engine 2 and in the longitudinal direction of the engine 2 at a distance from the second end of the engine 2. The set of electrical equipment 20 is arranged below a first imaginary horizontal level, the air inlet 9, 10, 11 is arranged above the first horizontal level, and the outlet 17 of the first exhaust duct section 16, 16a, 16b is arranged above a second imaginary horizontal level, the second horizontal level being located above the air inlet 9, 10, 11.

The set of electrical equipment 20 is thus arranged at a lowest level. The air inlet 9, 10, 11 is arranged above the set of electrical equipment 20, and the outlet 17 of the first exhaust duct section 16, 16a, 16b is arranged above said air inlet 9, 10, 11. The electrical equipment, and in particular any processor forming part of the electrical equipment, are sensitive to heat. The heat may reduce the reliability and/or lifetime of the electrical equipment. By arranging the air inlet 9, 10, 11 between the exhaust outlet 17 and the electrical equipment, the electrical equipment is protected from the heat of the exhaust gas. As the air inlet 9, 10, 11 is located above the electrical equipment 20, it is positioned farther from the ground level. It is beneficial to arrange any fuel supply pipes close to the ground level, and by arranging the air inlet 9, 10, 11 farther from the ground level, it is easier to arrange a sufficient safety distance between the air inlet 9, 10, 11 and any components having a potential gas leak risk.

In the embodiments of the figures, the air ducts of the power generation unit 1 comprise a first intake duct section 6, for supplying intake air to the first turbocharger 4a and a second intake duct section 7 for supplying intake air to the second turbocharger 4b. Each of the intake duct sections 6, 7 comprises an inlet 9, 10. Each inlet 9, 10 is configured to be connectable to an air filter 12, 13. Instead of the air filter 12, 13, the inlets 9, 10 could be connected to an upstream side intake duct sections. The intake air of the engine 2 could thus be taken farther from the engine 2.

In the embodiments of the figures, the air ducts further comprise a ventilation duct section 8, 8a, 8b, 8c, 8d. Also the ventilation duct section 8, 8a, 8b, 8c, 8d comprises an inlet 11. In the embodiments of the figures, the inlet 11 of the ventilation duct section 8 is connected to an air filter 14. Instead of the air filter 14, the ventilation duct section 8, 8a, 8b could be connected to an upstream side ventilation duct section to take the ventilation air farther from the engine 2.

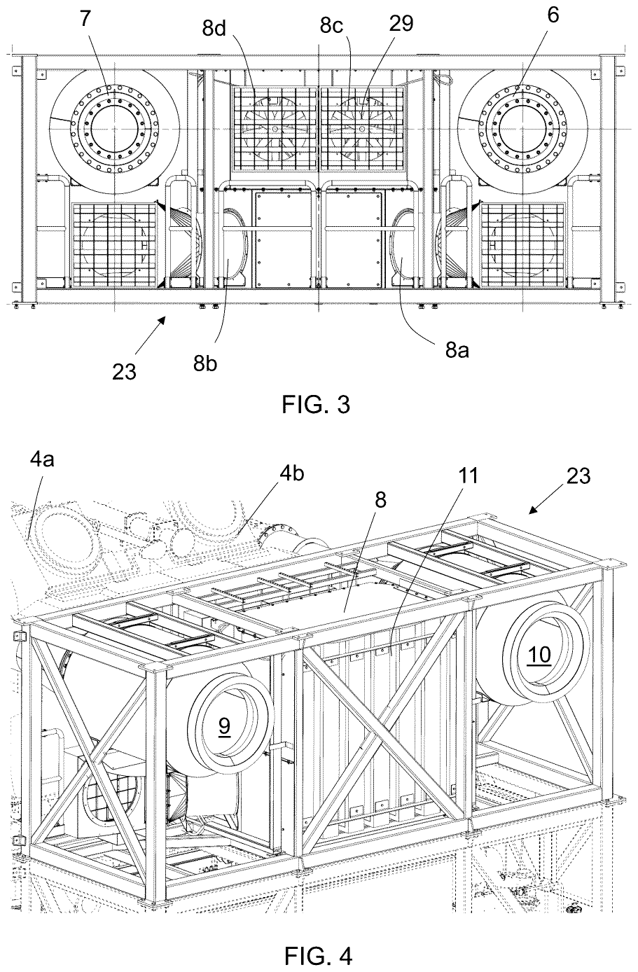

In the embodiments of the figures, the ventilation duct section 8, 8a, 8b, 8c, 8d comprises a common inlet 11 and several outlets. From the inlet 11, the ventilation air is divided into several branches 8a, 8b, 8c, 8d. The branches 8a, 8b, 8c, 8d allow distributing the ventilation air in an engine hall to a wider area. FIG. 3 shows two ventilation fans 29 that are configured for supplying ventilation air into an engine hall through two branches 8c, 8d of the ventilation duct 8. Also the other branches 8a, 8b of the ventilation duct can be provided with ventilation fans.

All the inlets 9, 10, 11 of the intake duct sections 6, 7 and the ventilation duct section 8, 8a, 8b, 8c, 8d are arranged below the outlet 17 of the first exhaust duct section 16, 16a, 16b and above the set of electrical equipment 20. In the embodiments of the figures, each of the intake duct sections 6, 7 runs from the respective inlet 9, 10 to the turbocharger 4a, 4b between the first and second imaginary horizontal levels. Also the ventilation duct section 8, 8a, 8b, 8c, 8d runs from the inlet 11 to the outlets between the first and second imaginary horizontal levels.

In the embodiments of the figures, the intake ducts 6, 7 and the ventilation duct 8, 8a, 8b, 8c, 8d create a heat shield zone between the first exhaust duct section 16, 16a, 16b and the set of electrical equipment. The ducts 6, 7, 8, 8a, 8b, 8c, 8d and the structures covering the ducts, in particular silencers arranged around the intake duct sections 6, 7, cover a major part of the footprint of the structure in which the set of electrical equipment 20 is arranged. Preferably, the ducts and the structures surrounding the ducts and/or the flow area of the air flowing through the inlets 9, 10, 11 cover at least 80 percent of the footprint. The electrical components are thus effectively protected from the heat of the exhaust gas.

In the embodiments of the figures, the intake duct section 6, 7 are arranged in a horizontal direction on opposite sides of the inlet 11 of the ventilation duct 8, 8a, 8b, 8c, 8d. Together the inlets 9, 10, 11 of the intake and ventilation duct sections thus create a broad air flow zone creating a heat shield zone above the electrical components arranged below the first horizontal level.

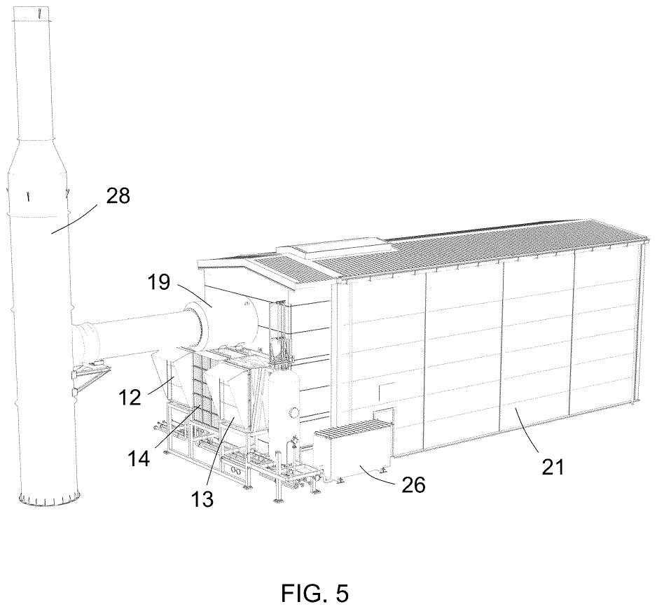

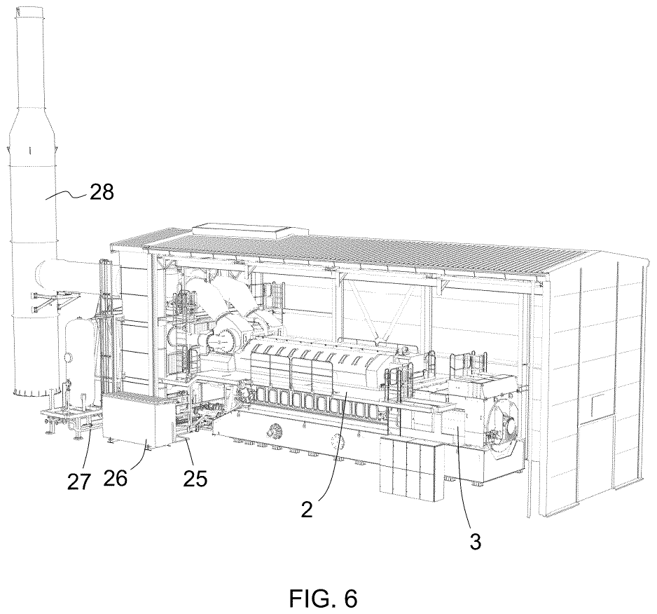

In the embodiment of FIGS. 5 and 6, the engine 2 and the generator 3 are arranged in an engine hall 21 that is configured to accommodate a single engine-generator set. The purpose of the ventilation duct section 8, 8a, 8b, 8c, 8d is to conduct into the engine hall 21 air for ventilating the engine hall 21. The purpose of the intake duct sections 6, 7 is to conduct intake air of the engine 2 to the turbochargers 4a, 4b. The intake air of the engine 2 is taken from outside of the engine hall 21. The air filters 12, 13 of the intake ducts 6, 7 are arranged outside of the engine hall 21. Also the air filter 14 of the ventilation duct 8 is arranged outside of the engine hall 21. FIGS. 5 and 6 also show a downstream side exhaust duct section 19 that is connected to the outlet 17 of the first exhaust duct section 16, 16a, 16b. The downstream side exhaust duct section 19 conveys exhaust gas to a smokestack 28.

Many modifications of the air ducts 6, 7, 8, 8a, 8b, 8c, 8d are possible. For instance, the engine 2 could be provided with a single turbocharger, in particular if the engine 2 is a line engine, or two turbochargers could be arranged in series. In that case a single intake duct section would be sufficient. Also, although it is beneficial to locate both the intake ducts and the ventilation ducts between the electrical equipment and the exhaust duct, the ventilation duct could be located differently. For instance, the ventilation air could be taken via the roof of the engine hall or from another end of the engine hall. Also, intake ducts extending outside of the engine hall 21 are not necessary. The power generation unit 1 could be provided with an air duct that is configured to convey both the intake air and the ventilation air into the engine hall 21. The intake air of the engine 2 could be taken from the inside of the engine hall 21. The air duct could be made larger to convey both the ventilation air and the intake air, or there could be two or more smaller diameter air ducts.

The ventilation air duct 8 is not necessary. The power generation unit 1 could be provided with one or more air inlets that are configured to supply air into an engine hall. The air inlets could thus be arranged in a wall of the engine hall. Through the inlets, both the ventilation air and the intake air of the engine 2 could be supplied. The intake air of the engine 2 could thus be taken from the engine hall. The air inlets could be provided with ventilation fans, but that is not necessary.

In the embodiments of the figures, the set of electrical equipment 20, the inlet 9, 10 of the air duct section 6, 7, 8, 6a, 8b, 8c, 8d and the outlet 17 of the first exhaust duct section 16, 16a, 16b are arranged in one or more self-supporting modules 22, 23, 24. In the embodiments of the figures, there are three modules 22, 23, 24. The modules 22, 23, 24 are arranged on top of each other. The expression “self-supporting” means here that each module 22, 23, 24 can be lifted and transported as a unit and at the construction site the modules 22, 23, 24 can be stacked without a need to construct additional support structures for the modules.

In the embodiments of the figures, the set of electrical equipment 20 is arranged in a first module 22, the inlet 9, 10 of the first air duct section 6, 7, 8 is arranged in a second module 23 and the outlet 17 of the first exhaust duct section 16, 16a, 16b is arranged in a third module 24. The first module 22 forms a lowermost module, the second module 23 is configured to be arranged on top of the first module 22, and the third module 24 is configured to be arranged on top of the second module 23. The first module 22 can be referred to as an auxiliary module, the second module 23 as an air module and the third module 24 as an exhaust module.

It is beneficial to arrange the different functions in separate modules. This also keeps the dimensions of the modules 22, 23, 24 relatively small and makes lifting and transporting of them easier. However, also other configurations are possible. For instance, the parts of the second module 23 and the third module 24 could be integrated into one module. The second module 23 could thus be made higher to accommodate also the inlet 17 of the first exhaust duct section 16, 16a, 16b.

In the embodiments of the figures, the flow area of the intake air and ventilation air extends substantially over the whole air module 23 in the lateral direction of the engine 2. This creates an effective heat shield zone between the auxiliary module 22 and the exhaust module 24. As the inlets 9, 10, 11 are located at an edge of the air module 23 that is located farther from the engine 2, the flow area extends substantially over the whole air module 23 also in the longitudinal direction of the engine 2.

According to an embodiment of the invention, the power generation unit 1 comprises means for adjusting the position of the first exhaust duct section 16, 16a, 16b to connect it to the turbocharger 4a, 4b. In the embodiments of the figures, the adjustment means are arranged in the third module 24. The adjustment means allow tolerances in the mutual distances between the turbocharger 4a, 4b and the third module 24 and facilitate safe installation of the power generation unit 1 at the construction site of a power plant and enable tight and reliable connections of the exhaust duct.

According to an embodiment of the invention, the power generation unit 1 comprises a double-walled fuel supply pipe 25 for supplying the first fuel to the engine 2. The fuel supply pipe 25 has an upstream side end that is configured to be connectable to an upstream side fuel supply pipe 27. The upstream side end of the fuel supply pipe 25 is arranged below the first imaginary horizontal level and in the lateral direction of the engine 2 outwards from the engine 2. The upstream side end of the fuel supply pipe 25 is arranged at a distance of at least 2 meters, preferably at least 3 meters, from any air inlet 9, 10, 11 and from the set of electrical equipment 20 of the power generation unit 1. A potential fuel leakage location is thus arranged far from air inlets that could conduct the fuel into the engine hall 21 or into the engine 2 and also from electrical equipment potentially generating sparks.

In the embodiments of the figures, the power generation unit 1 comprises a fuel supply module 26 comprising fuel connections for connecting the double-walled fuel supply pipe 25 to the upstream side fuel supply pipe 27. The fuel supply module 26 facilitates providing standardized and safe connections for fuel pipes. In the embodiments of the figures, the fuel supply module 26 is arranged outside of the engine hall 21. A potential fuel leakage location is thus located outside of the engine hall 21.

In the embodiments of the figures, the fuel supply module 26 is arranged from the positions of the inlets 9, 10 of the air duct section 6, 7, 8 and the set of electrical equipment 20 towards the first end of the engine 2. This allows arranging the connections of fuel pipes far from air inlets and electrical components.

Exhaust gas from the engine 2 can be conveyed to a smokestack 28. In the embodiments of the figures, each engine 2 is connected to an own smokestack 28. However, in case of a power plant comprising two or more power generation units 1, two or more engines 2 could be connected to a common smokestack.

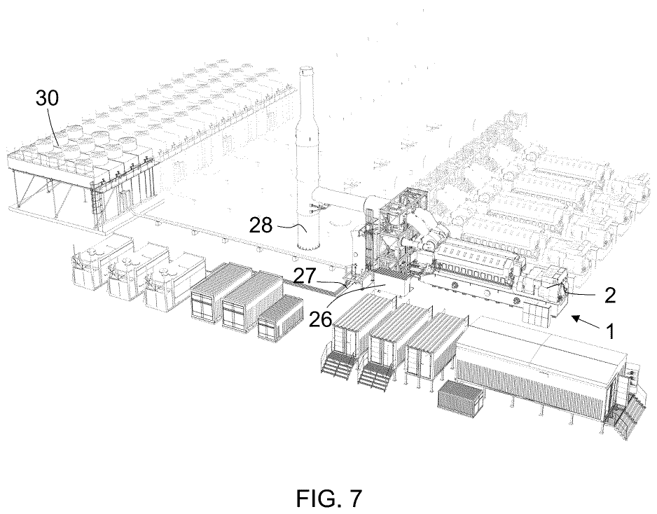

FIG. 7 shows a power plant according to an embodiment of the invention. The power plant comprises several power generation units 1 according to the invention, in the example of FIG. 7 there are five power generation units 1. FIG. 7 does not show the engine halls of the power generation units. Each power generation unit 1 could be arranged inside an own engine hall. Due to the modular structure of the power generation unit 1, the size of the power plant can be easily scaled up without a need to modify the power generation units 1. The power plant shown in FIG. 5 could thus be constructed with a smaller or larger number of the power generation units 1.

The power plant comprises a common main fuel supply pipe 27 that is configured to supply the gaseous fuel to each engine 2 of the power plant. Each power generation unit 1 is connected to the main fuel supply pipe 27 at a location that is at least two meters, preferably three meters from any air inlet 9, 10, 11 and the set of electrical equipment of the respective power generation unit 1 or any adjacent power generation unit 1.

In the embodiment of FIG. 7, the main fuel supply pipe 27 is arranged such that the air inlets 9, 10, 11 of the power generation units 1 are located between the main fuel supply pipe 27 and respective engines 2. This facilitates safe maintenance and service of the engines 2, as the main fuel supply pipe 27 is located farther from the engines 2.

FIG. 7 also shows cooling units 30 for the power generation units 1. The cooling units 30 comprise radiators for cooling the cooling liquid that is used for cooling the engines 2. Each cooling unit 30 is arranged on the second end side of the respective engine 2 at a distance from the second end. Also the cooling units 30 contribute to the scalability of the power plant, as each cooling unit 30 is configured to provide the required cooling power for one engine 2, and the number of cooling units 30 can be configured to equal the number of power generation units 1 in the power plant. As the cooling units 30 are arranged at the free ends of the engines 2, they allow safe maintenance and service of the generators 3.

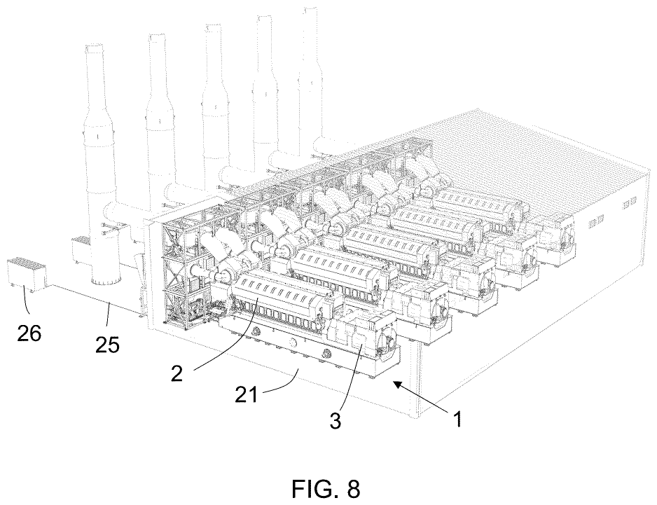

FIG. 8 shows a power plant according to another embodiment of the invention. In the embodiment of FIG. 8 all the engines 2 and generators 3 of the power generation units 1 are arranged within the same engine hall 21. However, the fuel supply modules 26 of the power generation units 1 are arranged outside the engine hall 21.

It will be appreciated by a person skilled in the art that the invention is not limited to the embodiments described above, but may vary within the scope of the appended claims.

1-29. (canceled)

30. A power generation unit for a power plant, the power generation unit comprising:
an internal combustion engine that is configured to be operable using at least a first, gaseous fuel, the engine having a first end and a second end;
a generator arranged at the first end of the engine and configured to be driven by the internal combustion engine;
at least one turbocharger;
at least one air inlet for introducing intake air into the turbocharger or air into a space surrounding the internal combustion engine;
a first exhaust duct section for conducting exhaust gas from the turbocharger, the first exhaust duct section including an outlet that is configured to be connectable to a second, downstream side exhaust duct section; and
a set of electrical equipment including components dedicated to controlling operation of the internal combustion engine, the generator and/or auxiliary equipment serving operation of the internal combustion engine and/or the generator, the components including at least one processor configured to control operation of the internal combustion engine, the generator and/or the auxiliary equipment;
wherein the at least one air inlet, the outlet of the first exhaust duct section and the set of electrical equipment are arranged on the second end side of the internal combustion engine and in a longitudinal direction of the internal combustion engine at a distance from the second end of the internal combustion engine, the set of electrical equipment is arranged below a first horizontal level, the air inlet is arranged above the first horizontal level, and the outlet of the first exhaust duct section is arranged above a second horizontal level, the second horizontal level being located above the air inlet.

31. A power generation unit according to claim 30, wherein the set of electrical equipment, the air inlet, and the outlet of the first exhaust duct section are arranged in one or more self-supporting modules.

32. A power generation unit according to claim 31, wherein the power generation unit comprises:
at least two self-supporting modules, and the set of electrical equipment is arranged in a first module, the air inlet is arranged in a second module, and the outlet of the first exhaust duct section is arranged in the second module or in an optional third module, the self-supporting modules being independently moveable and configured to be arranged one on top of the other such that the first module forms a lowermost module, the second module is configured to be arranged on top of the first module, and the optional third module is configured to be arranged on top of the second module.

33. A power generation unit according to claim 32, wherein the power generation unit comprises:
three self-supporting modules, and the outlet of the first exhaust duct section is arranged in the third module.

34. A power generation unit according to claim 30, wherein the air inlet is part of an air duct section that is configured for conducting intake air to the turbocharger or air into a space surrounding the internal combustion engine.

35. A power generation unit according to claim 34, wherein the air duct section is a ventilation duct section that is configured for conducting ventilation air into a space surrounding the internal combustion engine.

36. A power generation unit according to claim 30, wherein the air inlet is configured for introducing ventilation air into a space surrounding the internal combustion engine, and the power generation unit comprises:
at least one intake duct section for conducting air to the at least one turbocharger, the intake duct section including an inlet that is configured to be connectable to an upstream side intake duct section or to an air filter, the inlet of the intake duct section being arranged above the first horizontal level, and below the second horizontal level.

37. A power generation unit according to claim 32, wherein the inlet of said at least one intake duct section is arranged in the second module.

38. A power generation unit according to claim 36, wherein the power generation unit comprises:
at least a first turbocharger and a second turbocharger, and said at least one intake duct section comprises:
a first intake duct section configured for supplying intake air to the first turbocharger and a second intake duct section configured for supplying intake air to the second turbocharger.

39. A power generation unit according to claim 38, wherein the first intake duct section and the second intake duct section are arranged in a horizontal direction on opposite sides of the air inlet.

40. A power generation unit according to claim 38, wherein the first exhaust duct section comprises:
two branches, each of the two branches being connectable to one of the first and second turbochargers.

41. A power generation unit according to claim 40, wherein the two branches merge to form a single exhaust duct on the upstream side of the outlet of the first exhaust duct section.

42. A power generation unit according to claim 30, wherein air supply routes from one or more air inlets to the at least one turbocharger and/or into the space surrounding the internal combustion engine are configured such that flowing air and/or ducts conveying air and structures covering the ducts create between the first exhaust duct section and the set of electrical equipment a heat shield zone that covers at least 80 percent of a footprint of a structure in which the set of electrical equipment is arranged.

43. A power generation unit according to claim 30, wherein the power generation unit comprises:
a double-walled fuel supply pipe for supplying the first gaseous fuel to the internal combustion engine, the fuel supply pipe having an upstream side end configured to be connectable to an upstream side fuel supply pipe, said upstream side end being arranged below the first horizontal level and in a lateral direction of the internal combustion engine outwards from the internal combustion engine.

44. A power generation unit according to claim 43, wherein said upstream side end of the fuel supply pipe is arranged at a distance of at least 2 m from the air inlet and the set of electrical equipment.

45. A power generation unit according to claim 43, wherein the power generation unit comprises:
a fuel supply module including fuel connections for connecting the double-walled fuel supply pipe to the upstream side fuel supply pipe.

46. A power generation unit according to claim 45, wherein the fuel supply module is arranged from positions of the air inlet and the set of electrical equipment towards the first end of the internal combustion engine.

47. A power generation unit according to claim 30, wherein the power generation unit comprises:
an engine hall, inside which the internal combustion engine and the generator are arranged, the air inlet and the outlet of the first exhaust duct section being arranged outside of the engine hall.

48. A power generation unit according to claim 30, wherein the power generation unit comprises:
means for adjusting a position of the first exhaust duct section to connect it to the turbocharger.

49. A power generation unit according to claim 30, wherein the set of electrical equipment comprises any one or more of the following devices:
a frequency converter for controlling operation of a ventilation fan, an oil mist separator, a preheating circulation pump or a pre-lubrication pump; a turbo washing unit; a motor of a lube oil emptying pump; and/or a motor of a preheating circulation pump.

50. A power generation unit according to claim 30, wherein the internal combustion engine is a V-engine.

51. A power generation unit according to claim 30, in an arrangement of a power plant.

52. A power plant according to claim 51, wherein the power plant comprises:
a plurality of the power generation units.

53. A power plant according to claim 52, wherein the power plant comprises:
a common main fuel supply pipe that is configured to supply the first gaseous fuel to each power generation unit of the power plant.

54. A power plant according to claim 53, wherein each power generation unit is connected to the main fuel supply pipe at a location that is at least 2 meters from each air inlet and each set of electrical equipment of a respective power generation unit and any adjacent power generation unit.

55. A power plant according to claim 54, wherein the main fuel supply pipe is arranged outside of any engine halls accommodating internal combustion engines and generators of the plural power generation units.

56. A power plant according to claim 53, wherein the main fuel supply pipe is arranged such that the air inlet of each power generation unit is located between the main fuel supply pipe and respective internal combustion engine.

57. A power plant according to claim 51, wherein the arrangement comprises:
for each power generation unit, a cooling unit that is arranged on a second end side of each respective engine at a distance from the second end.

58. A power plant according to claim 57, wherein the cooling unit is arranged farther from the internal combustion engine than any fuel supply pipe supplying the first gaseous fuel to the internal combustion engines.
